(19) United States
(12) Patent Application Publication
(10) Pub. No.: US 2015/0260188 A1
(43) Pub. Date: Sep. 17, 2015

(54) SUPERCHARGER WITH ALIGNMENT MECHANISM BETWEEN INPUT AND ROTOR SHAFTS

(71) Applicant: EATON CORPORATION, Cleveland, OH (US)

(72) Inventor: William Bruce WITHERSPOON, Marshall, MI (US)

(21) Appl. No.: 14/724,239

(22) Filed: May 28, 2015

Related U.S. Application Data
(63) Continuation of application No. PCT/US2013/069871, filed on Nov. 13, 2013.
(60) Provisional application No. 61/730,658, filed on Nov. 28, 2012.

(51) Int. Cl. F04C 29/00; F02B 39/04; F02B 67/10; F04C 18/12

(52) U.S. Cl. CPC F04C 29/0071; F04C 18/126; F02B 39/04; F02B 67/10

(57) ABSTRACT

A compressor assembly includes: an input shaft configured to be coupled to an engine of a vehicle; a rotor shaft configured to be coupled to a compressor; a torque transfer module coupled to the input shaft and the rotor shaft, the torque transfer module being configured to transfer torque from the input shaft to the rotor shaft to drive the compressor; and an alignment mechanism that is positioned between the input shaft and the rotor shaft to axially align the input shaft relative to the rotor shaft.

This application is a Continuation of PCT/US2013/069871, filed 13 Nov. 2013, which claims benefit of U.S. patent application Ser. No. 61/730,658, filed 28 Nov. 2012 and which applications are incorporated herein by reference. To the extent appropriate, a claim of priority is made to each of the above disclosed applications.

### BACKGROUND

Supercharger compressors, such as roots-type blowers, can emit a distinctive noise during operation, especially at lower speeds, such as then the supercharger compressors are at idle. In some cases, this noise can be caused to misalignment of the input and rotor shafts that apply torque to turn the compressor rotors. This misalignment can lead to knocking/rattling and other undesirable noises.

### SUMMARY

In one aspect, a compressor assembly includes: an input shaft configured to be coupled to an engine of a vehicle; a rotor shaft configured to be coupled to a compressor; a torque transfer module coupled to the input shaft and the rotor shaft, the torque transfer module being configured to transfer torque from the input shaft to the rotor shaft to drive the compressor; and an alignment mechanism that is positioned between the input shaft and the rotor shaft to axially align the input shaft relative to the rotor shaft.

In another aspect, a compressor assembly includes: an input shaft configured to be coupled to an engine of a vehicle and defining a first bore at a first free end; a rotor shaft configured to be coupled to a compressor and defining a second bore at a second free end; a torque transfer module coupled to the input shaft and the rotor shaft, the torque transfer module being configured to transfer torque from the input shaft to the rotor shaft to drive the compressor; and a pin that is positioned in the first and second bores so that the pin extends between the input shaft and the rotor shaft to axially align the input shaft relative to the rotor shaft.

In yet another aspect, a method for transferring torque from an engine to a compressor assembly includes: extending an input shaft from the engine of a vehicle to the compressor assembly; extending a rotor shaft to a compressor of the compressor assembly; positioning an alignment mechanism between the input shaft and the rotor shaft to axially align the input shaft relative to the rotor shaft; and allowing torque to be transferred from the input shaft to the rotor shaft to drive the compressor.

### DESCRIPTION OF THE DRAWINGS

FIG. 1 is a schematic view of an example engine and supercharger system.

FIG. 2 is a schematic view of a portion of the supercharger of FIG. 1.

FIG. 3 is a side view of input and rotor shafts of the supercharger of FIG. 2.

FIG. 4 is a schematic view of a portion of the supercharger of FIG. 2.

FIG. 5 is a schematic view of a portion of another example supercharger.

### DETAILED DESCRIPTION

The present disclosure is directed towards supercharger compressors, such as roots-type blowers. In examples described herein, an input shaft of the supercharger is coupled (e.g., piloted) to the rotor shaft of the supercharger to minimize misalignment of the shafts. It will be appreciated that side designations are used herein for convenience only and are not intended to limit how the device may be used. In this regard, it will be appreciated that embodiments in accordance with the principles of the present disclosure can be used in any orientation.

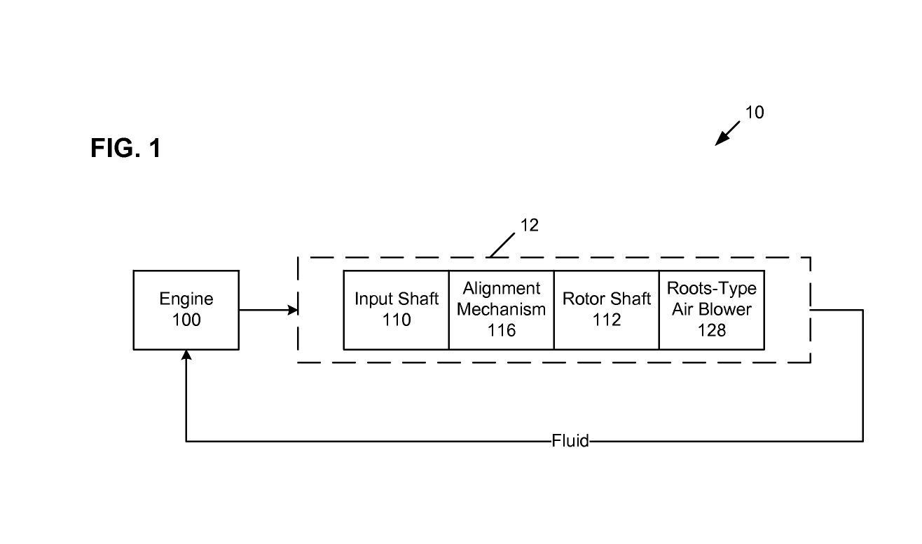

FIG. 1 is a schematic representation of an engine and supercharger system 10, including an engine 100 and a compressor assembly 12. In the embodiment illustrated, the engine 100 is an internal combustion engine, and the compressor assembly 12 is a portion of a supercharger, such as a roots-type blower.

In this example, the engine 100 drives (directly or indirectly through one or more intermediate members) an input shaft 110 of the compressor assembly 12. The input shaft 110 is, in turn, coupled to a rotor shaft 112 of the compressor assembly. An alignment mechanism 116 is positioned between the rotor shaft 112 and the input shaft 110. As described further herein, the alignment mechanism 116 functions to minimize misalignment of the shafts 110, 112.

The rotor shaft 112 is coupled (typically through a gear system) to a roots-type blower 128. The roots-type blower 128 is configured to compressor fluid (e.g., air) that is delivered to the engine 100. In this example, the roots-type blower 128 may comprise any air pump with parallel lobed rotors. A plurality of rotors may be disposed within the overlapping cylindrical chambers of the roots-type blower 128. Each of the rotors may be mounted on a rotor shaft for rotation therewith.

Additional details about the example roots-type blower 128 are described in U.S. Patent Application Publication No. 2009/0148330 to Swartzlander, entitled “Optimized Helix Angle Rotors for Roots-Style Supercharger,” and/or U.S. Patent Application Publication No. 2010/0086402 to Ouwenga et al., entitled “High Efficiency Supercharger Outlet,” the entireties of which are hereby incorporated by reference. Other types of compressors can also be used.

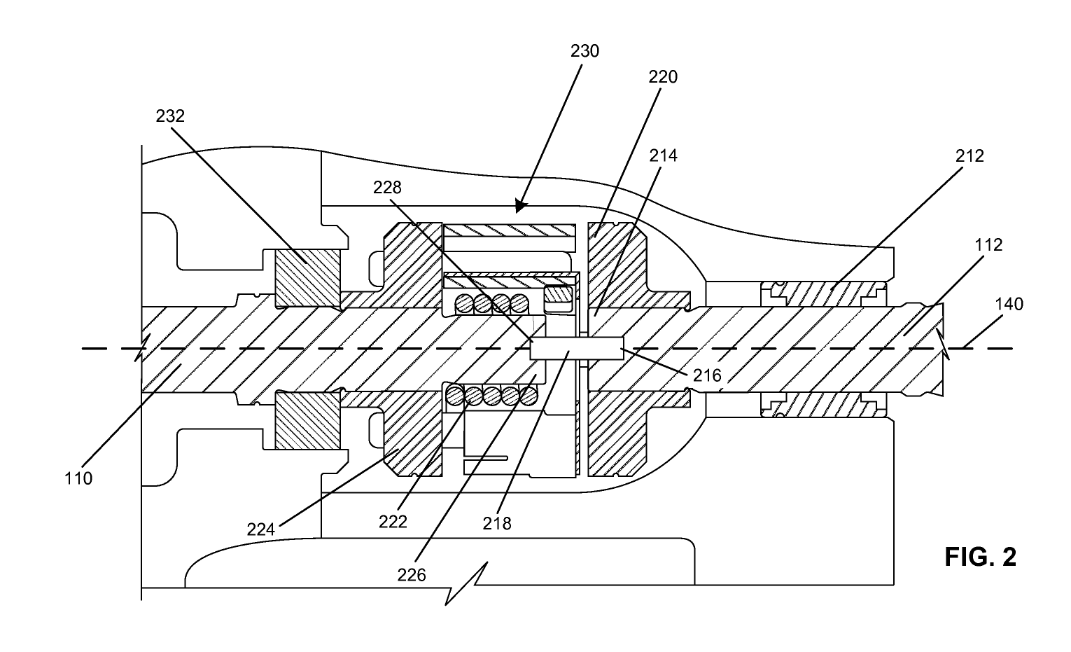

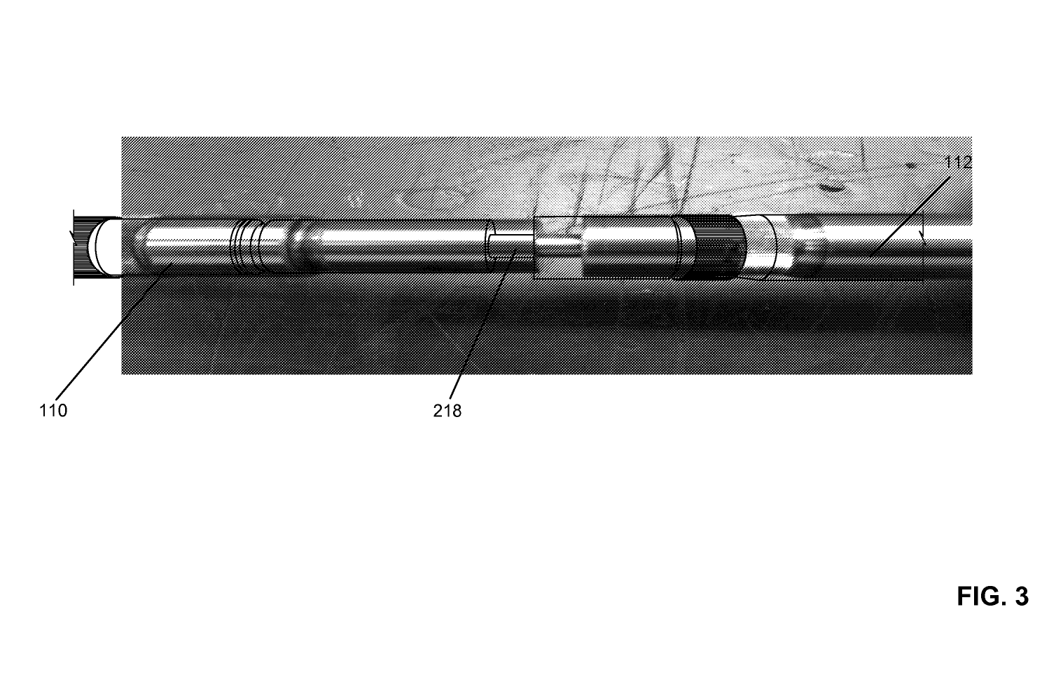

Referring now to FIGS. 2-4, additional details regarding the compressor assembly 12 are provided. In this example, the input to the compressor assembly 12 is shown.

The input shaft 110 is shown coupled to the rotor shaft 112. The input shaft 110 extends from the engine (not shown in FIGS. 2-4) to a free end 226. In turn, the rotor shaft 112 extends from a free end 214, positioned adjacent to the free end 226 of the input shaft 110, to drive the rotors of the roots-type blower (not shown in FIGS. 2-4).

The torque from the input shaft 110 is transferred to the rotor shaft 112 by a torsion dampening mechanism 230. The torsion dampening mechanism 230 includes an input hub 224 that is rotationally fixed to the input shaft 110. Likewise, an output hub 220 is rotationally fixed with respect to the rotor shaft 112. A torsion spring 222 extends between the input hub 224 and the output hub 220.

The torsion dampening mechanism 230 transfers the torque from the input shaft 110 to the rotor shaft 112. The torsion dampening mechanism 230 is configured to minimize noise associated with the transfer of torque. Additional details regarding this configuration can be found in U.S. Pat. No. 8,042,526 to Shuhocki et al., entitled “Torsion Damping Mechanism for a Supercharger,” the entirety of which is hereby incorporated by reference.

One or more bearings (not shown) function to locate the input shaft 110 relative to the engine and the torsion dampening mechanism 230, and locate the rotor shaft 112 relative to the torsion dampening mechanism 230 and the rotors. During use, the input shaft 110 can become misaligned relative to the rotor shaft 112. This can create undesired noise, such as knocking and/or rattling, particularly at lower speeds.

To alleviate this misalignment, an example alignment mechanism 116 (see FIG. 1) including a pin 218 is positioned to extend between the free end 226 of the input shaft 110 and the free end 214 of the rotor shaft 112. This pin 218 functions to align the input shaft 110 relative to the rotor shaft 112 along an axis 140 of the compressor assembly 12, thereby minimizing any misalignment between the shafts 110, 112.

The pin 218 is positioned in a first bore 228 formed in the input shaft 110 and a second bore 216 formed in the rotor shaft 112. The pin 218 is positioned so that each of the input shaft 110 and the rotor shaft 112 can spin independently of the other. In other words, the pin 218 functions to align the input shaft 110 and the rotor shaft 112, rather than to transfer any significant torque from the input shaft 110 to the rotor shaft 112.

In the example shown, the pin 218 is made of steel and has a 6 millimeter diameter. The bore 228 in the input shaft 110 extends approximately 12 millimeters from the free end 226 and is slightly more than 6 millimeters in diameter. The bore 216 extends approximately 10 millimeters from the free end 214 and is similar in diameter. Other sizes and dimensions can be used.

In this example, a liner 232 is positioned within the second bore 216. The liner 232 is configured to provide isolation between the pin 218 and the rotor shaft 112 to accommodate differences in tolerances associated with the pin 218 (e.g., differences in pin length and/or diameter). In this example, the liner member 232 is made of a polymeric and/or composite material such as nylon.

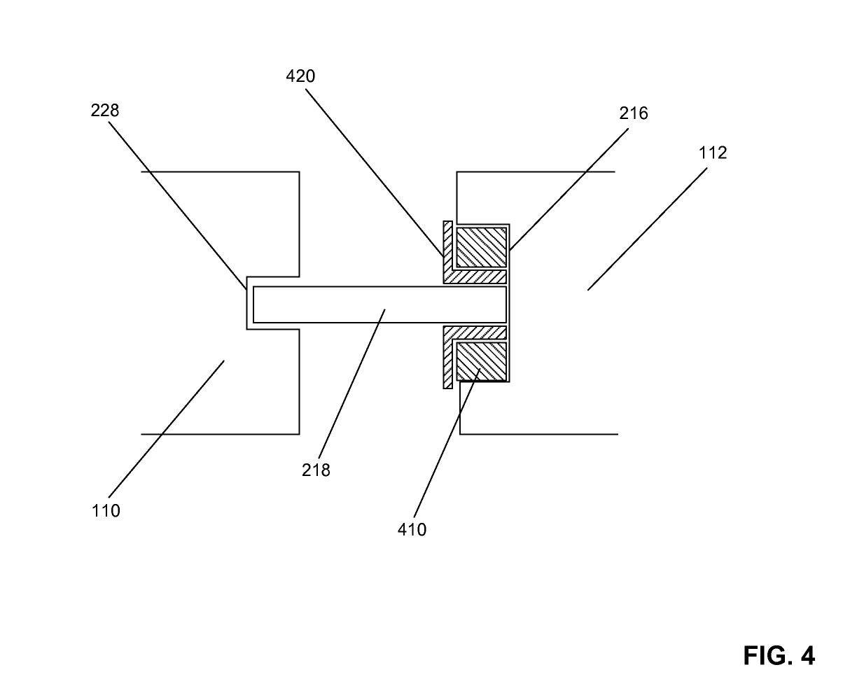

Referring to FIG. 4, another example interface between the pin 218 and the input shaft 110 and the rotor shaft 112 is shown. In this example, the bore 216 is sized to receive a liner member 410 and bushing member 420.

The liner member 410 is located within the bore 216 and is configured similarly to the liner 232 to provide isolation between the pin 218 and the rotor shaft 112. The bushing member 420 is positioned within the isolation member 410 and receives the pin 218. In this example, the bushing member 420 is made of steel and is impregnated with an oil. This allows the pin 218 to spin freely within the bushing member 420. Other configurations are possible.

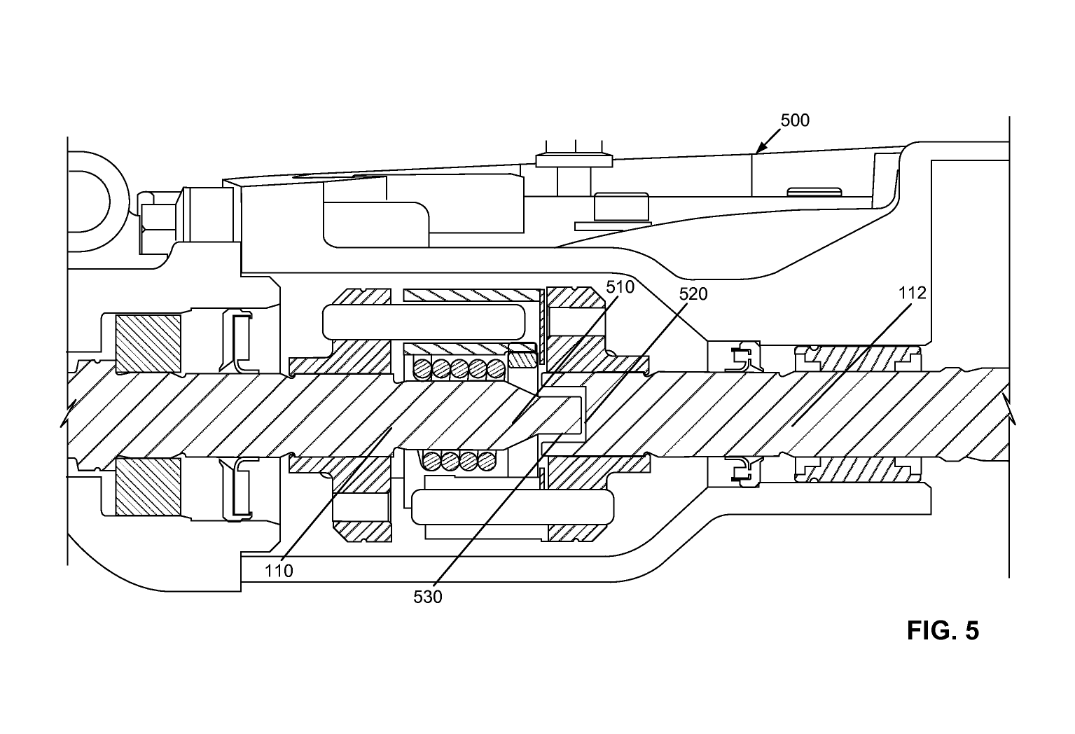

Referring now to FIG. 5, an alternative embodiment for a compressor assembly 500 is shown. The compressor assembly 500 is similar to that of the compressor assembly 12 described above. However, the input shaft 110 of the compressor assembly 500 forms a tapered end 510 that is sized to be received in a bore 520 formed in the rotor shaft 112. A bushing 530 is positioned in the bore 520 and surrounds the tapered end 510 so that the input shaft 110 can rotate independently of the rotor shaft 112.

The compressor assembly 500 eliminates the need for a separate pin, since the tapered end 510 functions to axially align the input shaft 110 relative to the rotor shaft 112. As noted previously, this axial alignment can function to minimize knocking and other undesired noises associated with misalignment of the shafts 110, 112.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A compressor assembly, comprising:
an input shaft;
a rotor shaft configured to be coupled to a compressor;
a torque transfer module coupled to the input shaft and the rotor shaft, the torque transfer module being configured to transfer torque from the input shaft to the rotor shaft to drive the compressor; and
an alignment mechanism between ends of the input shaft and the rotor shaft to axially align the input shaft relative to the rotor shaft without transferring significant torque between the input shaft and the rotor shaft.

2. The compressor assembly of claim 1, wherein the alignment mechanism is a pin.

3. The compressor assembly of claim 2, further comprising a first bore formed by one of the input shaft and the rotor shaft to accept the pin.

4. The compressor assembly of claim 3, further comprising second bore formed by another of the input shaft and the rotor shaft to accept the pin.

5. The compressor assembly of claim 4, wherein the pin is positioned within the first and second bores and extends from the input shaft to the rotor shaft to axially align the input shaft relative to the rotor shaft.

6. The compressor assembly of claim 1, wherein the torque transfer module further comprises:
an input hub that is rotationally fixed with respect to the input shaft; and
an output hub that is rotationally fixed with respect to the rotor shaft.

7. The compressor assembly of claim 6, wherein the torque transfer module further comprises a torsion spring that extends between the input hub and the output hub.

8. The compressor assembly of claim 1, wherein the alignment mechanism is formed by a free end of the input shaft that extends to the rotor shaft.

9. The compressor assembly of claim 8, wherein the free end is tapered to fit within a bore formed by the rotor shaft.

10. The compressor assembly of claim 1, wherein the compressor is a roots-type blower.

11. A compressor assembly, comprising:
an input shaft configured to be coupled to an engine of a vehicle and defining a first bore at a first free end;
a rotor shaft configured to be coupled to a compressor and defining a second bore at a second free end;
a torque transfer module coupled to the input shaft and the rotor shaft, the torque transfer module being configured to transfer torque from the input shaft to the rotor shaft to drive the compressor; and
a pin that is positioned in the first and second bores so that the pin extends between the input shaft and the rotor shaft to axially align the input shaft relative to the rotor shaft.

12. The compressor assembly of claim 11, wherein the torque transfer module further comprises:
an input hub that is rotationally fixed with respect to the input shaft; and
an output hub that is rotationally fixed with respect to the rotor shaft.

13. The compressor assembly of claim 12, wherein the torque transfer module further comprises a torsion spring that extends between the input hub and the output hub.

14. The compressor assembly of claim 11, wherein the compressor is a roots-type blower.

15. A method for transferring torque from an input shaft to a rotor shaft of a compressor assembly, the method comprising:
co-axially aligning the input shaft and the rotor shaft with an alignment mechanism between ends of the input and rotor shafts; and
transferring torque from the input shaft to the rotor shaft to drive the compressor while maintaining co-axial alignment with the alignment mechanism without transferring significant torque through the alignment mechanism.

16. The method of claim 15, wherein the alignment mechanism is a pin.

17. The method of claim 16, further comprising forming a first bore formed in the input shaft to accept the pin.

18. The method of claim 17, further comprising forming second bore in the rotor shaft to accept the pin.

19. The method of claim 18, further comprising positioning the pin within the first and second bores to extend from the input shaft to the rotor shaft to axially align the input shaft relative to the rotor shaft.

20. The method of claim 15, wherein the compressor is a roots-type blower.
